(19) United States
(12) Patent Application Publication
(10) Pub. No.: US 2019/0047228 A1
(43) Pub. Date: Feb. 14, 2019

(54) CALIBRATION OF ADDITIVE MANUFACTURING APPARATUS

(71) Applicant: RENISHAW PLC, Wotton-under-Edge, Gloucestershire (GB)

(72) Inventor: Ceri BROWN, Plaisance-du-Touch (FR)

(73) Assignee: RENISHAW PLC, Wotton-under-Edge, Gloucestershire (GB)

(21) Appl. No.: 16/078,072

(22) PCT Filed: Mar. 13, 2017
(86) PCT No.: PCT/GB2017/050671

§ 371 Date: Aug. 21, 2018

(30) Foreign Application Priority Data
Mar. 14, 2016 (GB) 1604298.8
Mar. 21, 2016 (GB) 1604728.4

(51) Int. Cl. B29C 64/393; B29C 64/153; B33Y 50/02; B33Y 30/00

(52) U.S. Cl. CPC B29C 64/393; B29C 64/153; B33Y 10/00; B33Y 30/00; B33Y 50/02

(57) ABSTRACT

A method of calibrating a scanner of an additive manufacturing apparatus, in which an energy beam is directed with the scanner to consolidate material in a working plane to build up a workpiece in a layer-by-layer manner. The method includes directing the energy beam with the scanner across a test surface in the working plane to form a test pattern, the test pattern having at least one periodic feature, capturing an image of the test pattern, determining from the image a periodic property of the test pattern and determining correction data for control of the scanner based upon the periodic property.

### FIELD OF INVENTION

This invention concerns a method for calibrating a scanner of an additive manufacturing apparatus and an additive manufacturing apparatus for carrying out the method. In particular, but not exclusively, the invention concerns a method for calibrating a scanner of an additive manufacturing apparatus comprising a material bed (e.g. powder or resin bed).

### BACKGROUND

Additive manufacturing or rapid prototyping methods for producing parts comprise layer-by-layer solidification of a material. There are various additive manufacturing methods, including powder bed systems, such as selective laser melting (SLM), selective laser sintering (SLS), electron beam melting (eBeam) and stereolithography, and non-powder bed systems, such as fused deposition modelling, including wire arc additive manufacturing (WAAM).

In selective laser melting, a powder layer is deposited on a powder bed in a build chamber and a laser beam is scanned across portions of the powder layer that correspond to a cross-section (slice) of the workpiece being constructed. The laser beam melts or sinters the powder to form a solidified layer. After selective solidification of a layer, the powder bed is lowered by a thickness of the newly solidified layer and a further layer of powder is spread over the surface and solidified, as required.

To form a workpiece accurately the scanner has to be calibrated.

WO94/15265 discloses placing a Mylar sheet with a large number of square cells printed thereon on a target surface and marking each cell with the laser beam. The sheet is then converted into digital form by scanning with a conventional digital scanner and the location of the laser mark relative to the centroid of the cell is used to update the correction factors for that cell. Such a calibration is carried out periodically.

U.S. Pat. No. 5,832,415 discloses a method for calibrating the deflection control of a laser beam for a rapid prototyping system. A light-sensitive medium is exposed to a laser beam at predetermined positions for generating a test pattern. A video camera is progressively moved across the produced test pattern so as to produce corresponding pattern portions of the test pattern with the camera. An evaluation program is used for composing the digitized pattern portions to an overall pattern. The picture coordinates of the overall pattern are compared with the digitized coordinates of a photomechanically produced reference pattern. A correction table required for control of the scanner for deflecting the laser beam is modified on the basis of the comparison.

U.S. Pat. No. 6,483,596 discloses a method for calibrating the control of a radiation device in a rapid prototyping system, wherein a calibration plate is arranged at a defined position in the rapid prototyping system. The calibration plate has an upper side with a first region and second region separate from the first region. The first region is provided with optically detectable reference crosses and the second region has a medium which is sensitive to the radiation of the radiation device. A test pattern of crosses is produced by exposing the medium to the radiation at predetermined desired positions defined by position coordinate data. The first and second regions are digitised, for example by means of a pixel scanner, a video camera or a digital camera, and correction data is calculated from comparing the reference crosses and crosses of the test pattern.

EP2186625 discloses a method to correct for geometric distortion of digital light projectors used in a rapid prototyping system. A camera is used to view an uncompensated test pattern created by each digital light projector. Each uncompensated test pattern is compared with the ideal test pattern to generate a pattern correction map.

WO2014/180971 discloses a method of automatic calibration of a device for generative production of a three-dimensional workpiece comprising first and second scanners. On an applied layer of material or a target, a first test pattern is produced using the first scanner and a second test pattern is produced using the second scanner. The first and second test patterns may be a specific grating pattern with a specific lattice constant or a dot pattern. A calibrated camera is used to capture an image of the first and second test patterns and compare the first and second test patterns to a reference pattern stored in memory of a control device. The first and second scanners are calibrated such that deviations of the corresponding test patterns from the reference pattern fall below a desired value. The calibration method may comprise an auto-correlation method or matching method.

It is desirable to provide a method of calibrating a scanner of an additive manufacturing apparatus to an accuracy that is an order of magnitude greater than a spatial resolution provided by pixels of an image capturing device used for the calibration.

### SUMMARY OF INVENTION

According to a first aspect of the invention there is provided a method of calibrating a scanner of an additive manufacturing apparatus, in which an energy beam is directed with the scanner to consolidate material in a working plane to build up a workpiece in a layer-by-layer manner, the method comprising directing the energy beam with the scanner across a test surface in the working plane to form a test pattern, the test pattern comprising at least one periodic feature, capturing an image of the test pattern, determining from the image a periodic property of the test pattern and determining correction data for control of the scanner based upon the periodic property.

By basing the correction on the periodic property of the test pattern more accurate correction data can be determined. In particular, the periodic property may be determined with more accuracy than a position of a geometric feature of the test pattern because the periodic property is based upon information determined from multiple ones of the geometric features (e.g. information averaged across multiple ones of the geometric features) rather than being dependent on a resolution of a single one of the geometric features.

The periodic property may be a phase shift of the test pattern relative to a reference phase. A phase of the test pattern may by indicative of an error in position of the energy beam when forming the test pattern and correction data is determined from the phase shift to correct positioning of the energy beam by the scanner.

A phase shift of a pattern can be determined from the image with a greater degree of accuracy than a position of one of the geometric elements of the pattern. Accordingly, basing the correction data on a determined phase shift can improve the accuracy of the correction data. Furthermore, a lower resolution imaging device, such as a camera, may be used compared to the prior art methods whilst still achieving the same or better accuracy for the correction data.

The phase shift may be determined through Fourier analysis of the image. The phase shift may be determined by carrying out a discrete Fourier transform of the image of the test pattern at a reference frequency and determining the phase shift of a resultant frequency component from the reference phase. A value for the phase shift may be determined for each region of plurality of different regions of the test pattern. Correction data may be determined by fitting a mathematical model of the scanner to the determined phase shifts. Each region may be less than a centimetre squared.

The method may comprise locating a reference surface of a calibration artefact in a working plane of the additive manufacturing apparatus, the reference surface having a reference pattern thereon, capturing an image of the reference pattern and determining the phase shift between the test pattern and the reference pattern. The image of the reference pattern may be captured using the same image capture device used to capture an image of the test pattern. The image capture device may be located in the same location(s) in the additive manufacturing apparatus for the capture of the images of the test pattern and the reference pattern. The reference surface may be located in the same location in the additive manufacturing apparatus as a surface on which the test pattern is formed. In this way, repeatable distortions in the test pattern introduced by the image capture device can be eliminated through comparison with the reference pattern which have been distorted in a corresponding manner, i.e. the image capture device is used as a comparator rather than a calibrated measuring device.

The method may comprise carrying out multiple discrete Fourier transforms of the image of the reference pattern at the reference frequency with a basic sinusoid used for the discrete Fourier transform spatially shifted relative to the image of the reference pattern to identify a position of the basic sinusoid that results in highest amplitude for the discrete Fourier transform. This may align the basic sinusoid with the position of the reference pattern in the image. The method may further comprise carrying out a discrete Fourier transform of the image of the test pattern using the basic sinusoid at the identified position relative to the image.

The test pattern may comprise a first pattern comprising a first geometric feature repeated in a first direction and a second pattern comprising a second geometric feature repeated in a second direction, perpendicular to the first direction. The first and second geometric features may be the same (but rotated to the corresponding first and second direction) or different. Each of the first and second directions may correspond to a spatial direction in which the energy beam is moved by a different steering element of the scanner. The first pattern and second pattern may be interspersed without overlap between the geometric features of each pattern.

The test pattern may comprise a series of parallel lines. The test pattern may comprise at least one first set of parallel lines that repeat in the first direction and at least one second set of parallel lines that repeat in the second direction. First sets of parallel lines may alternate with parallel lines of the second set across the test surface in both the first and second directions.

The repeated geometric feature of the test pattern may correlate with the regular spatial intervals of geometric features of a reference pattern and a phase shift may be determined by comparing a phase of the repeated geometric feature of the test pattern to a phase of the corresponding repeated geometric feature of the reference pattern.

The periodic property may comprise summed intensities across each of a plurality of regions of the test pattern in the image, each region comprising at least one period of the test pattern. The method may comprise forming different periodic features of the test pattern with different focal positions of the energy beam relative to the working plane. A periodic property, such as the summed intensity, may be determined for each region of the test pattern formed with the energy beam at one of the different focal positions and focussing optics of the scanner calibrated based upon variations in the summed intensity for the different regions.

The test pattern may comprise a recurring geometric feature, wherein each occurrence of the geometric feature is formed with the energy beam at a different focal position relative to the working plane.

According to a second aspect of the invention there is provided a method of calibrating a scanner of an additive manufacturing apparatus, in which an energy beam is directed and focussed with the scanner to consolidate material in a working plane to build up a workpiece in a layer-by-layer manner, the method comprising directing the energy beam across a test surface in the working plane with the scanner to form geometric features on the surface, wherein a focal position of the energy beam relative to the working plane is altered for the formation of different ones of the geometric features, capturing an image of the geometric features, determining an intensity per unit area for each region formed with a different focal position of the energy beam and determining from the variation in intensity per unit area, correction data for correcting control of the focal position of the scanner.

The geometric features may be marks formed on a surface by the energy beam or material consolidated with the energy beam.

According to a third aspect of the invention there is provided a controller for controlling an additive manufacturing apparatus, wherein the controller is arranged to carry out the method of the first or second aspect of the invention.

According to a fourth aspect of the invention there is provided an additive manufacturing apparatus for building up a workpiece in a layer-by-layer manner comprising a scanner for directing an energy beam to consolidate material in a working plane and a controller according to the third aspect of the invention.

The additive manufacturing apparatus may further comprise an image capture device for capturing an image of the working plane. The image capture device may comprise a camera. The camera may be located in the additive manufacturing apparatus at a location fixed relative to a datum used to locate the reference surface in the working plane. The apparatus may comprise a wiper arranged to be positioned relative to the datum to form material layers in the working plane.

According to a fifth aspect of the invention there is provided a data carrier having instructions thereon, which, when executed by a controller for controlling an additive manufacturing apparatus, cause the controller to carry out the method of the first or second aspect of the invention.

The data carrier may be a suitable medium for providing a machine with instructions such as non-transient data carrier, for example a floppy disk, a CD ROM, a DVD ROM/RAM (including—R/-RW and +R/+RW), an HD DVD, a Blu Ray™ disc, a memory (such as a Memory Stick™, an SD card, a compact flash card, or the like), a disc drive (such as a hard disc drive), a tape, any magneto/optical storage, or a transient data carrier, such as a signal on a wire or fibre optic or a wireless signal, for example a signals sent over a wired or wireless network (such as an Internet download, an FTP transfer, or the like).

According to a sixth aspect of the invention there is provided a fixture for mounting a plate in a working plane of an additive manufacturing apparatus, the fixture comprising a mounting surface for supporting the plate and a three-point mounting formation for contacting a surface to locate the mounting surface in a repeatable position in a direction perpendicular to the working plane.

The mounting surface may be for supporting a calibration plate comprising a reference pattern and a plate to be marked with a test pattern using the energy beam. The fixture may provide an aid to ensure that the reference pattern of the calibration plate and the plate to be marked with the test pattern are aligned in the same plane.

This ensures that in the above described calibration method, differences in images of the reference pattern and the test pattern do not arise because the patterns are located at different locations in the additive manufacturing apparatus.

According to a seventh aspect of the invention there is provided a method of carrying out additive manufacture of a workpiece, in which the workpiece is built by consolidating material in a layer-by-layer manner using an energy beam, the method comprising locating a preform in a working plane of an additive manufacturing apparatus, scanning an energy beam over the preform to form indicia on the preform, machining the preform to form a feature in the preform, wherein a location in which the feature is machined is based upon a location of the indicia, and, after machining the feature, building further features on the preform by consolidating material in layers using the energy beam.

By marking the preform with the energy beam, a location of the coordinate system of the energy beam relative to the preform can be determined and therefore, the feature can be machined into the preform in a location that matches that of the position of the coordinate system of the energy beam. Accordingly, the machined feature will be accurately located relative to the subsequently additively built further features. Such a method may be used in the manufacture of hybrid moulds comprising a base plate having cooling channels preformed therein and an additively built portion having conformal cooling channels arranged to be in fluidic communication with the cooling channels preformed in the base plate. Such a hybrid mould is described in U.S. Pat. No. 7,26,1550.

The indicia may comprise a pattern, the method comprising determining a location to form the feature by: capturing an image of the pattern, determining from the image a periodic property of the pattern and determining a location for the feature based upon the periodic property. The periodic property may be a phase of the pattern. The method may comprise adjusting a coordinate system of a machine tool used to form the feature and/or instructions instructing the machine tool in the formation of the feature based upon the determined phase.

According to an eighth aspect of the invention there is provided a method of carrying out additive manufacture of a workpiece, in which the workpiece is built by consolidating material in a layer-by-layer manner using an energy beam, the method comprising machining a preform to form a feature in the preform at a known location relative to indicia on the preform, and, after machining the feature, building a further feature on the preform by consolidating material in layers using the energy beam using an additive manufacturing apparatus, wherein a position in which the further feature is formed is based upon the position of the indicia on the preform.

The method may comprise forming the indicia by locating the preform in a working plane of the additive manufacturing apparatus and scanning an energy beam over the preform to form the indicia on the preform. In this way, a position of the indicia is set by the coordinate system of the additive manufacturing apparatus.

Alternatively, the method may comprise forming the indicia on the preform using another machine, such as the machine tool, such that a relative position of the indicia to the further feature is known and forming the further feature comprises detecting, with a sensor, a position of the indicia when the preform is placed in the additive manufacturing apparatus and consolidating material to form the further feature based upon the position of the indicia detected suing the sensor.

The indicia may comprise a pattern, the method comprising determining a location to form the feature by: capturing an image of the pattern, determining from the image a periodic property of the pattern and determining a location for the feature based upon the periodic property. The periodic property may be a phase of the pattern. The method may comprise adjusting a coordinate system of a machine tool used to form the feature and/or instructions instructing the machine tool in the formation of the feature based upon the determined phase.

### DESCRIPTION OF THE DRAWINGS

FIG. 1 shows an additive manufacturing apparatus according to an embodiment of the invention;

FIG. 2 is a plan view of a test pattern according to an embodiment of the invention for calibrating steering optics of a scanner;

FIG. 3 schematically shows a method of calibrating steering optics of a scanner of an additive manufacturing apparatus according to an embodiment of the invention;

FIG. 4 is a schematic view of typical pixel intensities in an image of the test pattern;

FIG. 5 is a plan view of a test pattern formed on a plate for calibrating focussing optics of the scanner;

FIG. 6 is a schematic view of an intensity graph generated from an image of the test pattern shown in FIG. 5;

FIG. 7 is a perspective view of fixture for mounting the calibration artefact and the test plate in the additive manufacturing apparatus shown from below;

FIG. 8 is a perspective view of the fixture from above; and

FIG. 9 schematically shows a method of forming a hybrid workpiece according to an embodiment of the invention.

### DESCRIPTION OF EMBODIMENTS

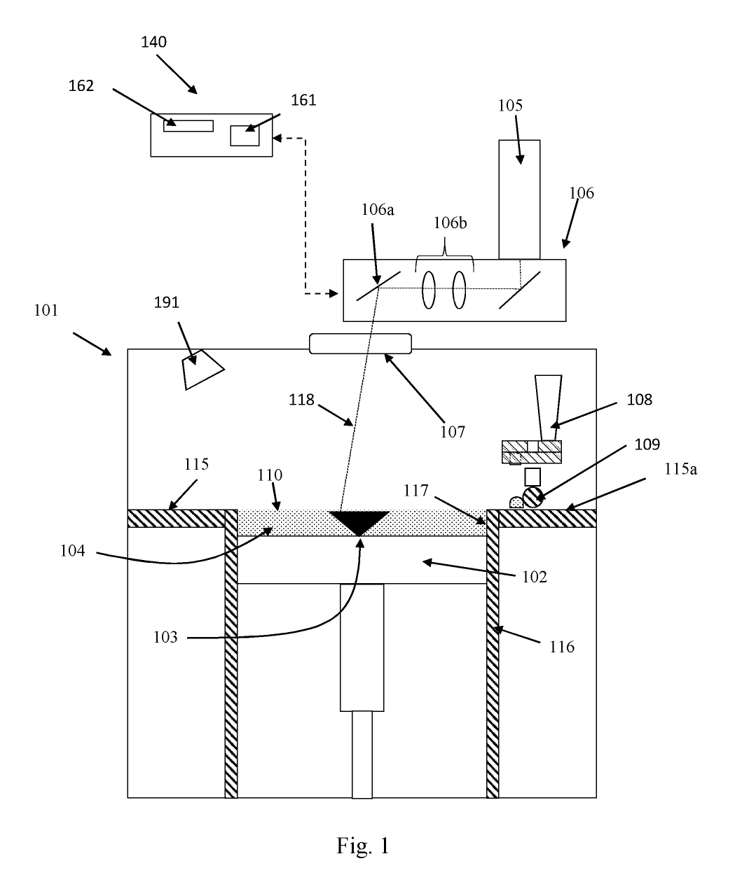

Referring to FIG. 1, an additive manufacturing apparatus according to an embodiment of the invention comprises a main chamber 101 having therein partitions 115, 116 that define a build chamber 117. A build platform 102 is lowerable in the build chamber 117. The build platform 102 supports a powder bed 104 and workpiece 103 as the workpiece is built by selective laser melting of the powder. The platform 102 is lowered within the build chamber 117 under the control of motor as successive layers of the workpiece 103 are formed.

Layers of powder 104 are formed as the workpiece 103 is built by dispensing apparatus 108 and a wiper 109. For example, the dispensing apparatus 108 may be apparatus as described in WO2010/007396. The dispensing apparatus 108 dispenses powder onto an upper surface 115a defined by partition 115 and is spread across the powder bed by wiper 109. A position of a lower edge of the wiper 109 defines a working plane 110 at which powder is consolidated and is adjustable.

A laser module 105 generates a laser beam 118 for melting the powder 104, the laser beam 118 directed as required by corresponding scanner, in this embodiment optical module 106. The optical module comprises steering optics 106a, such a two mirrors mounted on galvanometers, for steering the laser beam 118 in perpendicular directions across the working plane and focussing optics 106b, such as two movable lenses for changing the focus of the laser beam 118. The scanner is controlled such that the focal position of the laser beam 118 remains in the same plane as the laser beam 118 is moved across the working plane. Rather than maintaining the focal position of the laser beam in a plane using dynamic focusing elements, an f-theta lens may be used.

A camera 191 is located in the main chamber 101 for capturing images of the working plane.

A controller 140, comprising processor 161 and memory 162, is in communication with modules of the additive manufacturing apparatus, namely the laser module 105, optical module 106, build platform 102, dispensing apparatus 108, wiper 109 and camera 191. The controller 140 controls the modules based upon software stored in memory 162 as described below.

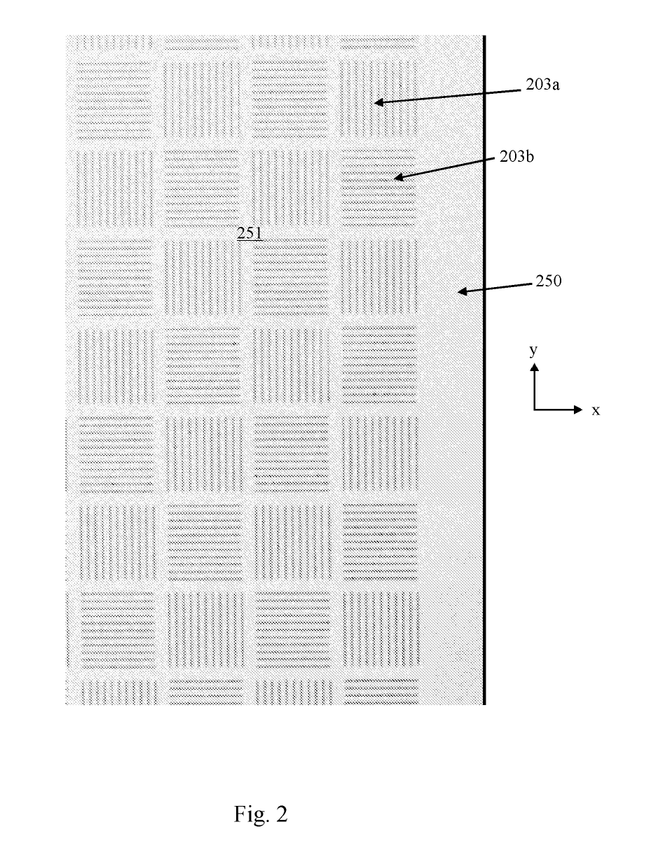

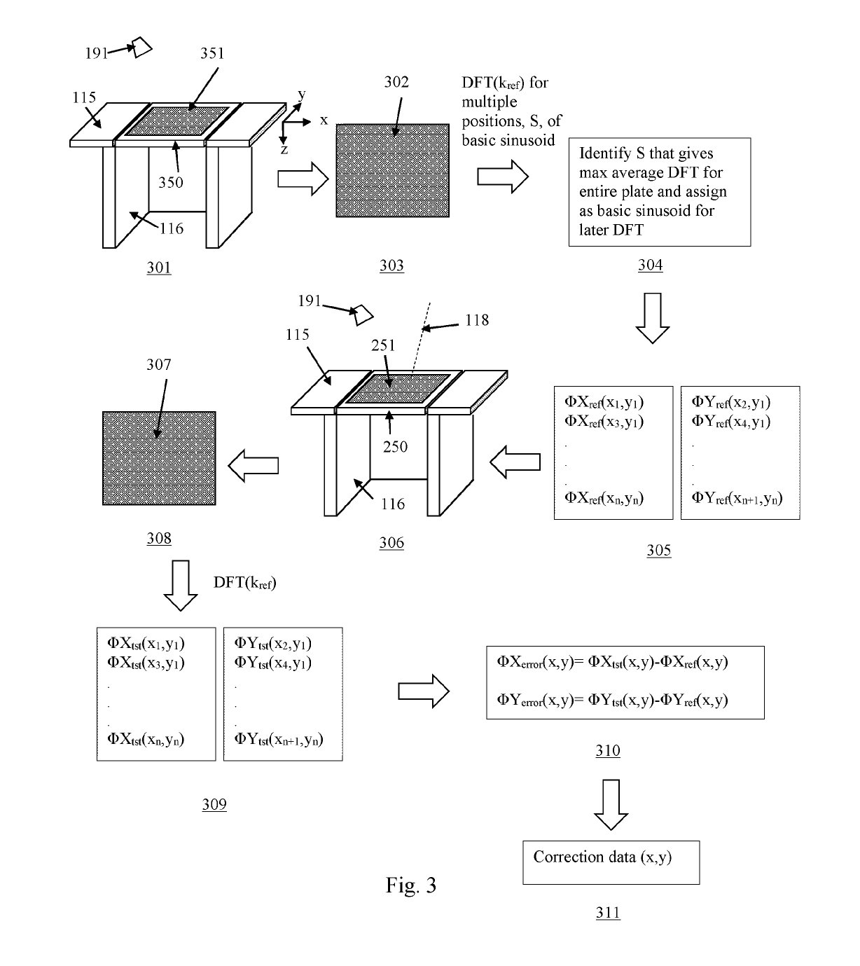

Referring to FIGS. 2 to 4, to calibrate the scanner 106 the user places 301 a calibration artefact 350 comprising a reference pattern 351 in the additive manufacturing apparatus such that the reference pattern 351 is located in the working plane 110. The reference pattern 351 may be located in the additive manufacturing apparatus using the fixture 400 described below with reference to

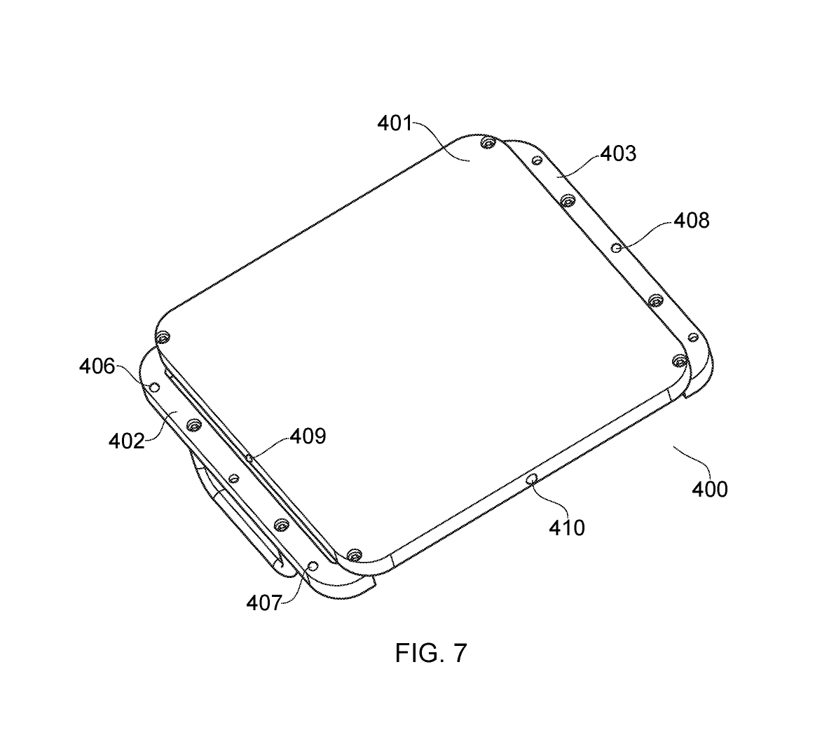

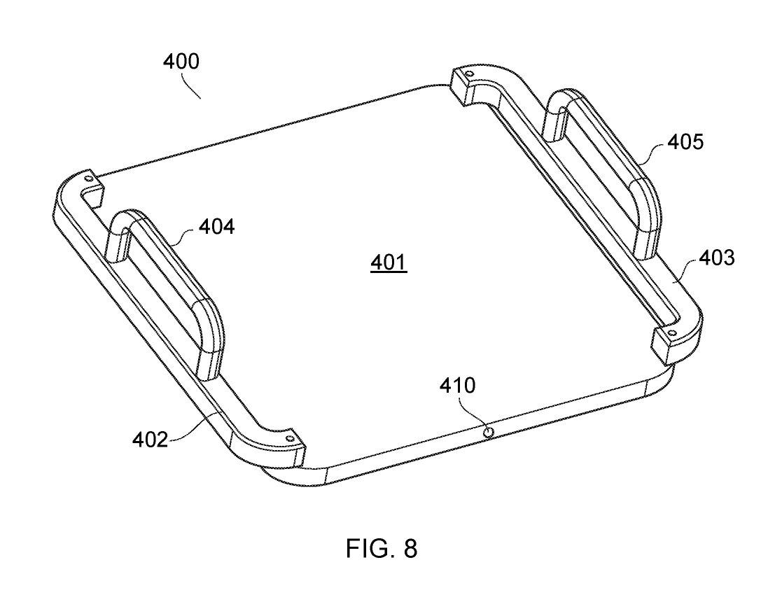

FIGS. 7 and 8. The reference pattern 351 is the same as the test pattern 251 shown in FIG. 2, with a plurality of regions 203a and 203b comprising a series of equally spaced parallel lines. Regions 203a comprise a plurality of parallel lines spaced apart in the x-direction and regions 203b comprise a plurality of parallel lines spaced apart in the y-direction. Regions 203a alternative with regions 203b in both the x- and y-directions.

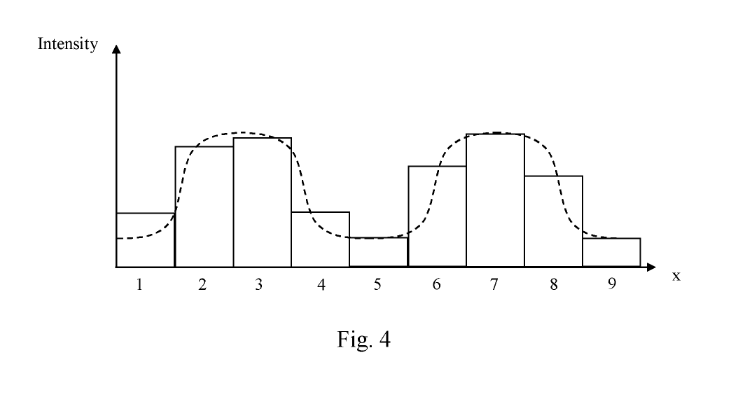

A period of the parallel lines is close to a period given by the Nyquist frequency for the camera 191, i.e. the period is close to four times the spatial resolution of a pixel of the camera 191 at the working plane. FIG. 4 shows how an intensity of pixels 1-9 may vary in an image of a portion of a region 203a, 203b of pattern 351, 251.

As can be appreciated from FIG. 4, determination of a position of an individual line from such an image will be of the order of the spatial resolution of the image.

The reference pattern 351 may be printed on a sheet using a suitable technique that is capable of printing patterns to a required accuracy, in this embodiment to an accuracy of a micron or less.

An image 302 of the reference pattern 351 in the working plane is captured 303 using the camera 191.

A series of discrete Fourier transforms (DFTs) are determined 304 at the known reference frequency, k_{ref}, of the parallel lines of the reference pattern 351, each using a basic sinusoid shifted to a different position. In this embodiment, the DFT is carried out by multiplying the image 302 of the reference pattern 351 by digitally generated sine and cosine representations. The sine and cosine representations are generated such that non-zero sine and cosine regions are spaced apart by zero value regions corresponding to the spaces between regions 203a, 203b. To determine a correct alignment of the digitally generated sine and cosine representations with the image of the reference pattern, DFTs are determined using the sine and cosine representations positioned at different positions, S, relative to the image of the reference pattern. A magnitude for the DFT is determined for each region and the magnitudes for all regions averaged. The position of the sine and cosine representation that results in the highest average magnitude for the DFT is deemed to be the position, S_{ref}, that most closely matches the position of the reference pattern 351 in the image 302.

A phase ΦX_{ref}, ΦY_{ref} of the reference pattern in each region, denoted by position (x,y) corresponding to the centre of the region, relative to the basic sinusoid is determined 305 from the DFT and identifying the reference phase for the region. For regions having a pattern with a feature that recurs in the x-direction, a phase shift ΦX_{ref} in the x-direction is determined and, for regions having a pattern with a feature that recurs in the y-direction, a phase shift ΦY_{ref} in the y-direction is determined. The phase shift is determined from the arctan of the quotient of the two values obtained by multiplying the image by the sine and cosine representations.

The reference artefact 350 is then removed from the additive manufacturing apparatus and replaced 306 with an aluminium plate 250 that is also located in the working plane, for example using the fixture 400 of FIGS. 7 and 8 that is locatable in a repeatable position in the build chamber 117. The test pattern 251 is then marked onto the aluminium plate 250 using the laser beam 118 and the scanner 106.

An image 307 of the test pattern 251 is captured 308.

A discrete Fourier transform of the image 308 of the test pattern 251 is determined 307 at the reference frequency, k_{ref}, and a phase ΦXₜₛₜ, ΦYₜₛₜ of the test pattern 251 from the basic sinusoid in each region 203a, 203b is determined 309.

A phase shift ΦXₑᵣᵣₒᵣ, ΦYₑᵣᵣₒᵣ of the test pattern 251 from the reference pattern 351 for each region 203a, 203b is determined 310. A mathematical model, as is known in the art, of the scanner 106 is then fitted to the determined phase shifts ΦXₑᵣᵣₒᵣ, ΦYₑᵣᵣₒᵣ for each region 203a, 203b to determine 311 correction data, in terms of values for calibration tables, for modifying control of the steering optics 106a of the scanner 106.

It is possible for such a method to provide accuracy of measurement to a resolution of 1/100^{th} of a pixel. Accordingly, if each pixel has a spatial resolution at the working plane of 150 μm, the method can provide a measurement accuracy of 1 or 2 μm.

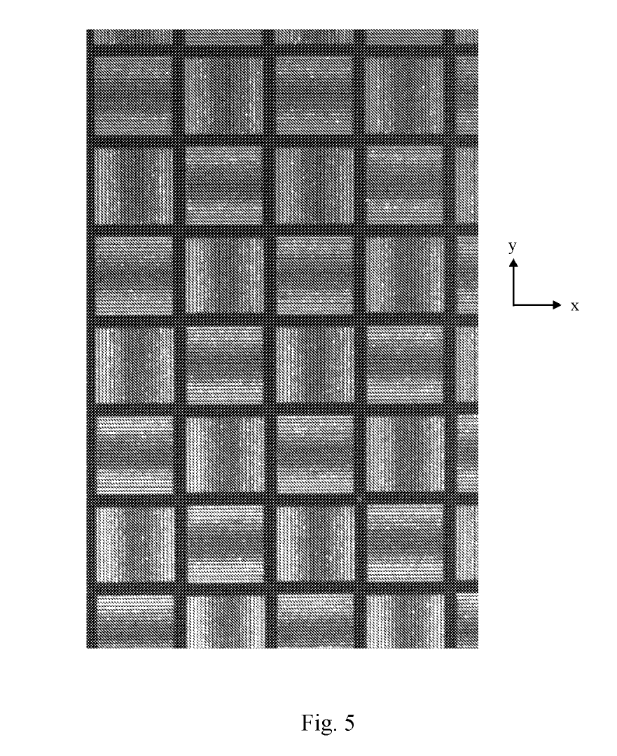

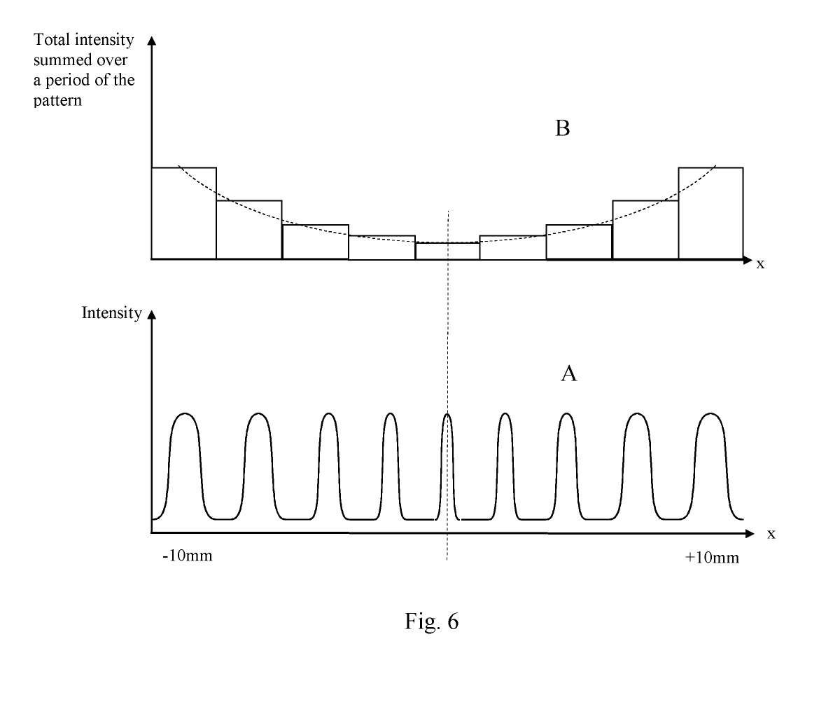

Referring to FIGS. 5 and 6 the focussing optics of the scanner 106 are calibrated by forming a test pattern 251 as shown in FIG. 2 on an aluminium sheet located in the working plane wherein the scanner 106 is controlled to vary a focal point of the laser beam for each line of the pattern of a region, for example, from −10 mm below the working plane to +10 mm above the working plane. This may result in a pattern on the aluminium sheet as shown in FIG. 5.

An intensity in an image of the pattern may vary as shown in graph A of FIG. 6, with thicker light lines formed at the edge of the pattern where the laser beam is not focussed in the working plane 110 to thinner light lines at the centre of a pattern where the laser beam is focussed in the working plane 110. The total intensity over each period of the pattern is summed to produce graph B. As the focal point of the laser beam is moved from being out of focus to in focus on the working plane, the total intensity for a period of the pattern reduces as a thickness of the line reduces. Fitting a curve to the summed intensities can be used to correct control of the focusing optics 106b of the scanner 106.

A fixture 400 for mounting the calibration artefact 350 and aluminium plate 250 is shown in FIGS. 7 and 8. The fixture comprises a support 401 for supporting the calibration artefact/aluminium plate and wings 402, 403 for mounting the support 401 in place in the build chamber 117. The wings 402, 403 are offset relative to a supporting surface of the support 401 such that the wings 402, 403 are located above and to the side of the support 401 when the fixture 400 is located in the additive manufacturing apparatus. The wings 402, 403 comprise handles 404, 405 for manipulation of the fixture 400 and mounting elements 406, 407 and 408 for kinematically locating a calibration artefact/aluminium plate supported by the fixture 400 in a repeatable vertical position in the build chamber 117. In this embodiment, the elements 406, 407 and 408 comprise three balls that provide point surfaces for contacting surface 115a at three spaced apart positions.

The fixture 400 comprises two further positioning elements 409 and 410 for locating the support 401 in a fixed position in the x and y directions. The elements 409 and 410 each comprise a ball mounted in a recess in the support 401 and biased outwardly from the support 401 by springs (not shown) such that, upon insertion of the support into the build chamber 117, the balls engage a wall of the build chamber 117 and are deflected against the biasing of the springs, the biasing holding the fixture 400 in place.

Both the calibration artefact 350 and aluminium plate 250 have a suitable shape for mounting on support 401.

The method may further comprise aligning a lower edge of the wiper 109 with surface 115a that is used for alignment of the fixture 400, and therefore, the calibration artefact 350, such that the wiper 109 forms powder layers in the working plane 110. Alignment of the wiper 109 with the surface 115a may be carried out using known methods. Using the same datum for alignment of the wiper 109 and positioning of the calibration artefact 350 ensures that the powder layer is aligned with the working plane for which the scanner 106 is calibrated. Choosing a fixed surface 115a for the datum rather than a movable surface, such as the build platform 102, ensures that errors in alignment do not arise from lack of repeatability/inaccuracy in the positioning of the movable surface, such as the build platform 102.

An absolute position of an x, y coordinate system of the scanner 106 in the x- and y-directions relative to the build volume defined by build chamber 117 may be unknown because a position of the reference pattern 351 in the x- and y-direction may be unknown. However, the method calibrates the scanner 106 to correct for distortions in a coordinate system of the scanner 106. Accordingly, the above calibration method calibrates the scanner 106 based upon a position of the reference pattern 351 in the additive manufacturing apparatus.

The calibration method as described above could be used to calibrate each scanner in a multi-laser additive manufacturing apparatus. Each scanner could be used to mark patterns on one or more test plates and the phase shifts in the patterns formed by each scanner relative to the reference pattern used to calibrate the scanner.

A position of the coordinate system of the scanner 106 may not be known with sufficient accuracy if the additive built workpiece is to be aligned with non-additively built features, for example on substrate 501. For example, it is known to build hybrid additive parts in which a first portion of the part comprises a preformed substrate and a second portion of the part is additively built. On example of such a hybrid additive part is a mould insert in which cooling liquid channels are machined into the substrate prior to building the remainder of the mould insert using an additive process. The mould insert is formed with conformal cooling channels that connect with the cooling liquid channels in the substrate. Such a workpiece is described in U.S. Pat. No. 7,261,550.

In processes, wherein a substrate on which an additively built workpiece is built is premachined with features to be aligned with the additively built workpiece, it is important that a position of the machined features in a coordinate system of the scanner 106 are known such that the desired alignment can be achieved.

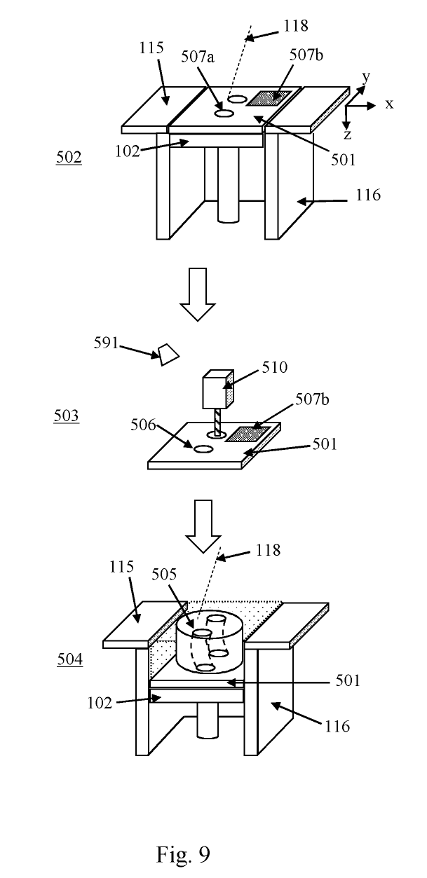

In accordance with an embodiment of the invention as shown in FIG. 9, the method of forming a hybrid workpiece may comprise locating a build substrate 501 that is to form part of the hybrid workpiece, but without the preformed features, on the build platform 102 of the additive manufacturing apparatus. The build substrate 501 and build platform 102 may comprise mounting formations for kinematically locating the build substrate 501 in a repeatable position on the build platform 102, for example as described in WO2015/092442.

The laser 105 and calibrated scanner 106 are controlled to mark 502 indicia 507 on the build substrate 501 that can be used to identify locations on the build substrate 501 in which features 506 are to be preformed. For example, in the case of preformed cooling channels, the locations of openings of the channels in a top surface of the build substrate 501 may be marked 507a. In a further embodiment, rather than marking the build substrate 501 with indicia 507a corresponding to a shape of a feature to be formed, indicia 507b may be formed that can be identified by a machine tool used to form the features 506 and used to align a coordinate system of the machine tool 510 with a coordinate system of the scanner 106. The indicia 507b may be selected for the ease of recognition and determination of position using a camera 591. For example, the indicia 507b may comprise a pattern similar to that described with reference to FIG. 2, wherein a position of the pattern is resolved by determining a phase of the pattern formed on the build substrate 501 with the laser beam 118.

The build substrate 501 is then removed from the additive manufacturing apparatus and mounted on a machine tool 510 for formation of the features 506. The features 506 are formed 503 by the machine tool at a location in the build substrate 501 based upon the location of the indicia 507 on the build substrate 501. For example, a location of the indicia on the build substrate 510 may be identified using camera 591, such as a video probe or the like, mounted in the machine tool 510. The position of the indicia 507 relative to the features 506 to be machined is known and the machine tool 510 can adjust its coordinate system or machine tool instructions to align the formation of the features to the indicia. In this example, the features 506 are channels formed in the substrate 501.

The substrate 501 is then remounted on the build platform 102, the kinematic mounting elements ensuring that the build substrate 501 is mounted in the same position as the position it was in when marked with the indicia 507. The additively built portion 505 of the hybrid workpiece is then built 504 using the additive manufacturing apparatus. Alignment of the preformed features 506 with the additively built portion 505 is ensured as a result of the indicia being formed by the calibrated scanner 106 used to form the subsequent additively built portion 505.

In an alternative embodiment, the indicia 507 are formed using the machine tool 510 and a location of the indicia on the build substrate 510 may be identified using camera 591, such as a video probe or the like, mounted in the additive manufacturing apparatus. Once the additive manufacturing apparatus has detected a position of the indicia, the additive manufacturing apparatus may build the portion 505 in a position based upon the position of the indicia. As the machined features 506 are built in a specified position relative to the indicia and the additively built portion 505 is built in a specified position relative to the indicia, the relative positions of the machined features 506 and the additively built potion 505 should also be correct. There is no need to detect the machined features 506, which may be difficult to detect with the required accuracy as they are not specifically built for recognition by the camera.

It will be understood that modification and alterations to the above described embodiments may be made without departing from the scope of the invention as defined herein. For example, the pattern may not comprise separate regions 203a, 203b from which correction data (a phase) for the x- and y-directions is calculated but may comprise a single region from which periodic components can be calculated for both perpendicular directions.

1.-34. (canceled)

35. A method of calibrating a scanner of an additive manufacturing apparatus, in which an energy beam is directed with the scanner to consolidate material in a working plane to build up a workpiece in a layer-by-layer manner, the method comprising directing the energy beam with the scanner across a test surface in the working plane to form a test pattern, the test pattern comprising at least one periodic feature, capturing an image of the test pattern, determining from the image a periodic property of the test pattern and determining correction data for control of the scanner based upon the periodic property.

36. A method according to claim 35, wherein the periodic property is a phase shift of the test pattern relative to a reference phase.

37. A method according to claim 36, wherein the phase shift is determined through Fourier analysis of the image.

38. A method according to claim 37, wherein the phase shift is determined by carrying out a discrete Fourier transform of the image of the test pattern at a reference frequency and determining the phase shift of a resultant frequency component from the reference phase.

39. A method according to claim 36, wherein a value for the phase shift is determined for each region of plurality of different regions of the test pattern.

40. A method according to claim 36, wherein correction data is determined by fitting a mathematical model of the scanner to the determined phase shifts.

41. A method according to claim 36, comprising locating a reference surface of a calibration artefact in a working plane of the additive manufacturing apparatus, the reference surface having a reference pattern thereon, capturing an image of the reference pattern and determining the phase shift between the test pattern and the reference pattern.

42. A method according to claim 41 wherein the image of the reference pattern is captured using the same image capture device used to capture the image of the test pattern.

43. A method according to claim 42, wherein the image capture device is located in the same location in the additive manufacturing apparatus for the capture of the images of the test pattern and the reference pattern.

44. A method according to claim 41, wherein the reference surface is located in the same location in the additive manufacturing apparatus as a surface on which the test pattern is formed.

45. A method according to claim 35, wherein the test pattern comprises a first pattern comprising a first geometric feature repeated in a first direction and a second pattern comprising a second geometric feature repeated in a second direction, perpendicular to the first direction.

46. A method according to claim 45, wherein the first and second geometric feature is the same but rotated to align with the corresponding first and second directions.

47. A method according to claim 45, wherein each of the first and second directions correspond to a spatial direction in which the energy beam is moved by a different steering element of the scanner.

48. A method according to claim 45, wherein the first pattern and second pattern are interspersed without overlap between the geometric features of each pattern.

49. A method according to claim 35, wherein the test pattern comprises a series of parallel lines.

50. A method according to claim 41, wherein the repeated geometric feature of the test pattern correlates with the regular spatial intervals of geometric features of the reference pattern and the phase shift is determined by comparing a phase of the repeated geometric feature of the test pattern to a phase of the corresponding repeated geometric feature of the reference pattern.

51. A method according to claim 35, wherein the periodic property comprises summed intensities across each of a plurality of regions of the test pattern in the image, each region comprising at least one period of the test pattern.

52. A method according to claim 35, comprising forming different periodic features of the test pattern with different focal positions of the energy beam relative to the working plane, wherein the periodic property is determined for each region of the test pattern formed with the energy beam at one of the different focal positions, and determining correction data for calibrating focussing optics of the scanner based upon the periodic property.

53. A method according to claim 52, wherein the test pattern comprises a recurring geometric feature, wherein each occurrence of the geometric feature is formed with the energy beam at a different focal position relative to the working plane.

54. A method of calibrating a scanner of an additive manufacturing apparatus, in which an energy beam is directed and focussed with the scanner to consolidate material in a working plane to build up a workpiece in a layer-by-layer manner, the method comprising directing the energy beam across a test surface in the working plane with the scanner to form geometric features on the surface, wherein a focal position of the energy beam relative to the working plane is altered for the formation of different ones of the geometric features, capturing an image of the geometric features, determining an intensity per unit area for each region formed with a different focal position of the energy beam and determining from the variation in intensity per unit area, correction data for correcting control of the focal position of the scanner.

55. A controller for controlling an additive manufacturing apparatus, wherein the controller is arranged to carry out the method of claim 35.

56. An additive manufacturing apparatus for building up a workpiece in a layer-by-layer manner comprising a scanner for directing an energy beam to consolidate material in a working plane and a controller according to claim 55.

57. An additive manufacturing apparatus according to claim 56, comprising a camera, wherein the camera is located in the additive manufacturing apparatus at a location fixed relative to a datum used to locate the reference surface in the working plane.

58. An additive manufacturing apparatus according to claim 57, comprising a wiper arranged to be positioned relative to the datum to form material layers in the working plane.

59. A data carrier having instructions thereon, which, when executed by a controller for controlling an additive manufacturing apparatus, cause the controller to carry out the method of claim 35.

60. A controller for controlling an additive manufacturing apparatus, wherein the controller is arranged to carry out the method of claim 54.

61. An additive manufacturing apparatus for building up a workpiece in a layer-by-layer manner comprising a scanner for directing an energy beam to consolidate material in a working plane and a controller according to claim 60.

62. A data carrier having instructions thereon, which, when executed by a controller for controlling an additive manufacturing apparatus, cause the controller to carry out the method of claim 54.
